(19) United States
(12) Patent Application Publication
(10) Pub. No.: US 2012/0209605 A1
(43) Pub. Date: Aug. 16, 2012

(54) METHOD AND APPARATUS FOR DATA EXPLORATION OF INTERACTIONS

(75) Inventors: Eyal Hurvitz, Ramat-Gan (IL); Maya Gorodetsky, Modiin (IL); Ezra Daya, Petah-Tikwah (IL); Oren Pereg, Amikam (IL)

(73) Assignee: Nice Systems Ltd., Ra'anana (IL)

(21) Appl. No.: 13/026,314

(22) Filed: Feb. 14, 2011

(51) Int. Cl. G10L 15/26; G06F 17/30

(52) U.S. Cl. 704/235; 707/748; 707/E17.009; 704/E15.043

(57) ABSTRACT

Retrieving data from audio interactions associated with an organization. Retrieving the data comprises: receiving a corpus containing interactions; performing natural language processing on a text document representing an interaction from the corpus; extracting at least one keyphrase from the text document; assigning a rank to the at least one keyphrase; modeling relations between at least two keyphrases using the rank; and identifying topics relevant for the organization from the relations.

### TECHNICAL FIELD

The present disclosure relates to interaction analysis in general, and to a method and apparatus for exploring automatic transcripts of interactions, in particular.

### BACKGROUND

Large organizations, such as commercial organizations, financial organizations or public safety organizations conduct numerous interactions with customers, users, suppliers or other persons on a daily basis. A large part of these interactions are vocal, or at least comprise a vocal component, while others may include text in various formats such as e-mails, chats, accesses through the web or others.

Speech-to-text (S2T) technologies, used for producing automatic texts from audio signals have made significant advances, and currently text can be extracted from vocal interactions such as but not limited to phone interactions with higher accuracy and detection level than before, meaning that many of the words appearing in the transcription were indeed said in the interaction (precision), and that many of the said words appear in the transcription (recall rate).

Depending on their quality, such transcripts can provide significant insight into the most important sources of knowledge about clients and the issues bothering them. The issues may include receiving information about the organization's products or services, information related to comparison to competitors' products or services, complaints, threatening to leave, or the like. Thus, receiving information by exploration of interactions, including vocal interactions will consequently enable to yield business insights from users' interactions in a call center.

However, when no prior knowledge of the organizational content and context is available, extracting valuable information from automatic transcripts is significantly less inefficient and more labor-intensive.

In particular, it is required to understand and define the specific business terms and concepts of the company and the discipline it belongs to, such as banking, airlines, technical support or the like, for further focused analysis. For example, customers in a banking call center would raise issues related for example to “credit cards”, “mortgage”, “loans” and “internet access”, while customers of an airline call center would bring up issues like “baggage”, “reservations” and “arrivals”. Some issues are inter-connected and may have hierarchical or other interrelations. For instance, the issue of “Complaints” could relate to and be a “parent” issue of issues such as “Credit Card Limit”, “Missing Luggage”, “Internet Access” or the like.

The tedious task of uncovering the issues raised by customers in a call center is currently carried out manually by humans listening to calls and reading textual interactions of the call center.

There is therefore a need in the art for a method and apparatus that will enable the automation of exploring business cases from transcribed calls and reduce the time and resources spent on this task.

### SUMMARY

A method and apparatus for retrieving data from audio interactions associated with an organization.

One aspect of the disclosure relates to a method for retrieving data from audio interactions associated with an organization, the method comprising: receiving a corpus comprising a text document representing an interactions; performing natural language processing on the text document; extracting one or more keyphrases from the text documents; assigning a rank to one or more of the keyphrases; modeling relations between at least two keyphrases using the rank; and identifying topics relevant for the organization from the relations. Within the method, each interaction is optionally an audio interaction, the method optionally further comprising performing audio analysis on the audio interaction to obtain the text document. Within the method, the audio analysis optionally comprises performing speech to text of the audio interactions. Within the method, the audio analysis optionally comprises one or more items selected from the group consisting of: word spotting of an audio interaction; call flow analysis of an audio interaction; talk analysis of an audio interaction; and emotion detection in an audio interaction. Within the method, the natural language processing optionally comprises one or more items selected from the group consisting of: part of speech tagging; word stemming; and stop words removal. Within the method, a keyphrases is optionally ranked within the corpus. The method can further comprise visualizing the topics. The method can further comprise capturing the audio interactions. Within the method, the interaction is optionally selected from the group consisting of: e-mail, chat session, blog post; and social media post.

Another aspect of the disclosure relates to an apparatus for retrieving data from interactions associated with an organization, comprising: a natural language processing engine for processing a text document representing an interaction; a keyphrase extraction component for extracting one or more keyphrases from the text document; a keyphrase ranking component for assigning a rank to one or more keyphrase; a relation modeling component for determining one or more relations between two or more keyphrases using the rank; and a topic selection component for identifying topics relevant for the organization from the relations. Within the apparatus, the interaction is optionally an audio interaction, the apparatus further comprising an audio analysis engine for analyzing the audio interaction and obtaining the text document. Within the apparatus, the audio analysis engine is optionally a speech to text engine. Within the apparatus, the audio analysis engine is optionally one or more items selected from the group consisting of: a word spotting engine; a call flow analysis engine; a talk analysis engine; and an emotion detection engine. Within the apparatus, the keyphrases are optionally ranked within the corpus. The apparatus can further comprise a user interface component for visualizing the topics. The apparatus can further comprise a capturing or logging component for capturing or logging the audio interactions. Within the apparatus, the interaction is optionally selected from the group consisting of: e-mail, chat session, blog post; and social media post.

Yet another aspect of the disclosure relates to a computer readable storage medium containing a set of instructions for a general purpose computer, the set of instructions comprising: receiving a corpus comprising one or more interactions associated with an organization, performing natural language processing on a text document representing an interaction form the corpus; extracting one or more keyphrases from the text document; assigning a rank to one or more of the keyphrases; modeling relations between two or more of the keyphrases using the rank; and identifying topics relevant for the organization from the relations.

### BRIEF DESCRIPTION OF THE DRAWINGS

The present invention will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a block diagram of the main components in an apparatus for exploration of audio interactions, and in a typical environment in which the method and apparatus are used, in accordance with the disclosure;

FIG. 2 is a schematic flowchart detailing the main steps in a method for data exploration of automatic transcripts, in accordance with the disclosure; and

FIG. 3 is an exemplary embodiment of an apparatus for data exploration of automatic transcripts, in accordance with the disclosure.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter relates to automating the process of obtaining information from vocal interactions. The process is currently time consuming and human labor intensive, and requires a preparatory stage of analyzing the terms, disciplines and concepts frequently used in the organization, and their interrelations.

Technical aspects of the solution can relate to an apparatus and method for capturing interactions from various sources and channels, transcribing the vocal interactions if available, and further processing the transcriptions and additional textual information sources, to obtain insights into the organization's activities. The textual analysis may comprise Natural Language Processing (NLP) analysis, key phrase extraction in which important terms and concepts are extracted from the text, key phrase ranking in which the terms and concepts are ranked according to their importance, and modeling of semantic relations between concepts. The results can be visualized or otherwise output to a user.

In some embodiments, the user can enhance, add, delete, correct or otherwise manipulate the results of any of the stages, or import additional information from other systems.

The method and apparatus enable the derivation and extraction of descriptive and informative topics from a set of interactions, wherein the audio interactions are processed to obtain texts such as automatic transcripts, the topics reflecting common or important issues of the input data set. The extraction enables a user to explore relations and associations between objects and topics expressed in the input data, and to apply convenient visualization of graphs for presenting relations between the objects and indicating the intensity of relations. The method and apparatus further enable the grouping of semantically similar texts, and optionally providing hierarchical presentation of the groups. Such hierarchy representation can further help exploring and evaluating the volume of business cases as expressed in call center interactions, and discovering new types of business cases which may have not been known to the organization in advance.

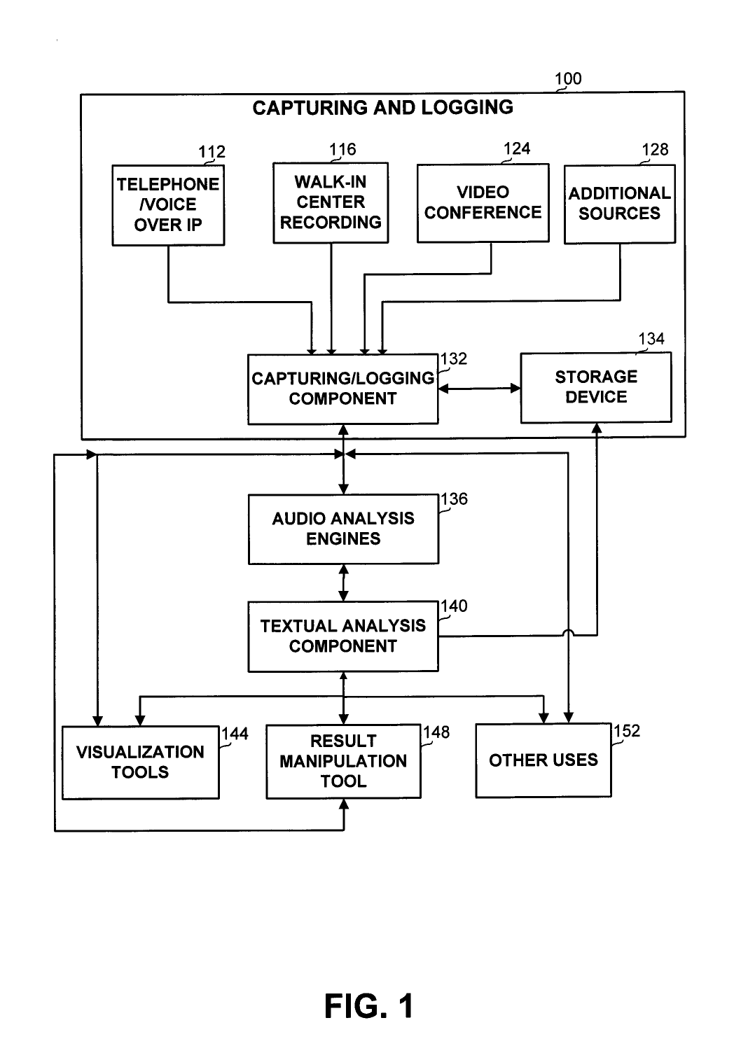

Referring now to FIG. 1, showing a block diagram of the main components in an exemplary embodiment of an apparatus for exploration of audio interactions, and in a typical environment in which the method and apparatus are used. The environment is preferably an interaction-rich organization, typically a call center, a bank, a trading floor, an insurance company or another financial institute, a public safety contact center, an interception center of a law enforcement organization, a service provider, an internet content delivery company with multimedia search needs or content delivery programs, or the like. Segments, including broadcasts, interactions with customers, users, organization members, suppliers or other parties are captured, thus generating input information of various types. The information types optionally include auditory segments, video segments, textual interactions, and additional data. The capturing of voice interactions, or the vocal part of other interactions, such as video, can employ many forms, formats, and technologies, including trunk side recording, extension side recording, summed audio, separate audio, various encoding and decoding protocols such as G729, G726, G723.1, and the like.

The interactions are captured using capturing or logging components 100. The vocal interactions are usually captured using telephone or voice over IP session capturing component 112.

Telephone of any kind, including landline, mobile, satellite phone or others is currently a main channel for communicating with users, colleagues, suppliers, customers and others in many organizations. The voice typically passes through a PABX (not shown), which in addition to the voice of one, two, or more sides participating in the interaction collects additional information discussed below. A typical environment can further comprise voice over IP channels, which possibly pass through a voice over IP server (not shown). It will be appreciated that voice messages or conference calls are optionally captured and processed as well, such that the handling is not limited to two-sided conversations. The interactions can further include face-to-face interactions which may be recorded in a walk-in-center by walk-in center recording component 116, video conferences comprising an audio component which may be recorded by a video conference recording component 124, and additional sources 128. Additional sources 128 may include vocal sources such as microphone, intercom, vocal input by external systems, broadcasts, files, streams, or any other source. Additional sources 128 may also include non vocal and in particular textual sources such as e-mails, chat sessions, facsimiles which may be processed by Object Character Recognition (OCR) systems, blog posts, social media posts or sessions or others, information from Computer-Telephony-Integration (CTI) systems, information from Customer-Relationship-Management (CRM) systems, or the like. Additional sources 128 can also comprise relevant information from the agent's screen, such as screen events sessions, which comprise events occurring on the agent's desktop such as entered text, typing into fields, activating controls, or any other data which may be structured and stored as a collection of screen occurrences, but also as screen capture.

Data from all the above-mentioned sources and others is captured and may be logged by capturing/logging component 132. Capturing/logging component 132 comprises a computing platform executing one or more computer applications as detailed below. The captured data may be stored in storage 134 which is preferably a mass storage device, for example an optical storage device such as a CD, a DVD, or a laser disk; a magnetic storage device such as a tape, a hard disk, Storage Area Network (SAN), a Network Attached Storage (NAS), or others; a semiconductor storage device such as Flash device, memory stick, or the like. The storage can be common or separate for different types of captured segments and different types of additional data. The storage can be located onsite where the segments or some of them are captured, or in a remote location. The capturing or the storage components can serve one or more sites of a multi-site organization. Storage 134 may also contain data and programs relevant for audio analysis, such as speech models, speaker models, language models, lists of words to be spotted, or the like.

Optional audio analysis engines 136 may be used for processing received audio interactions, or interactions that comprise an audio component. Audio analysis engines 136 receive vocal data of one or more interactions and process it using audio analysis tools, such as speech-to-text (S2T) engine which provides continuous text of an interaction, a word spotting engine which searches for particular words said in an interaction, emotion analysis, or the like. The audio analysis can depend on data additional to the interaction itself. For example, depending on the number called by a customer, which may be available through CTI information, a particular list of words can be spotted, which relates to the subjects handled by the department associated with the called number.

The operation and output of one or more engines can be combined, for example by incorporating spotted words, which generally have higher confidence than words found through general-purpose S2T process, into the text output by an S2T engine; searching for words expressing anger in areas of the interaction having high levels of emotion and incorporating such spotted words into the transcription, or the like.

The output of audio analysis engines 136 is thus a collection of texts related to audio interactions, such as textual representations of one or more vocal interactions.

The output of audio analysis engines 136, as well as interactions which are a-priori textual, such as e-mails, chat sessions, blog posts, text entered by an agent and captured as a screen event, or the like, are then passed to textual analysis component 140.

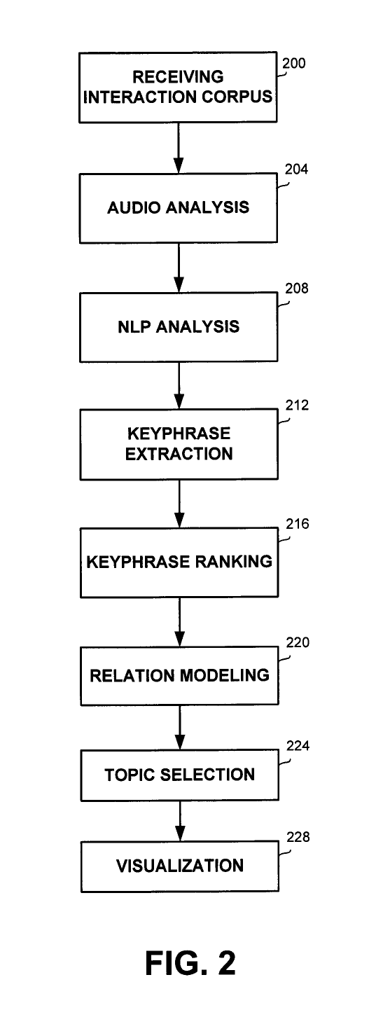

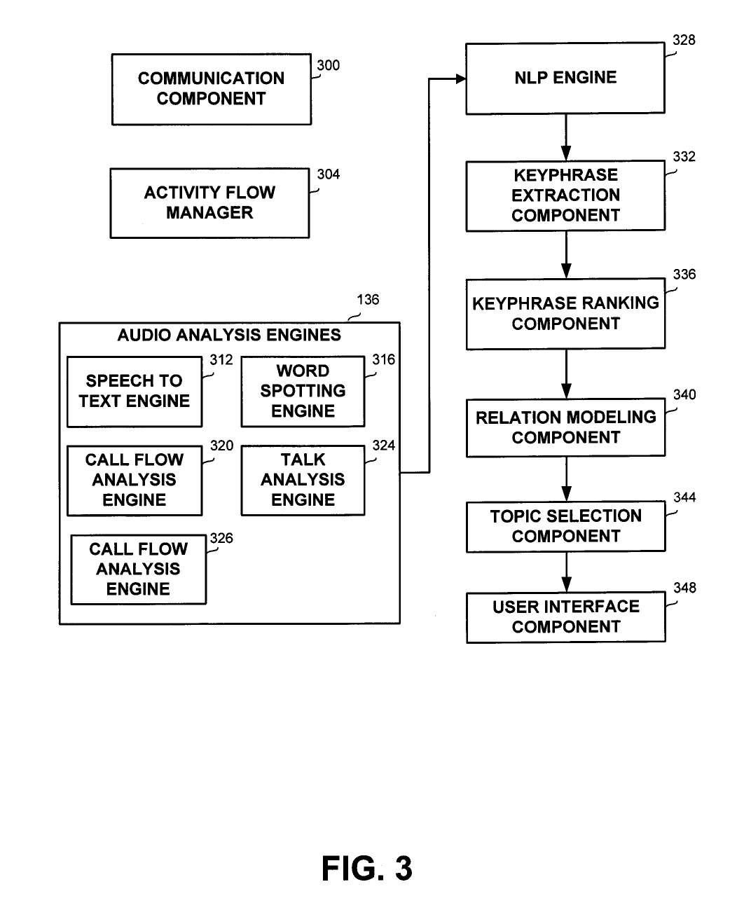

Textual analysis components 140 process the textual representation of the interactions, to obtain topics, terms, concepts, or hierarchies thereof which may be relevant for the organization. The text analysis is further detailed in association with FIG. 2 and FIG. 3 below.

The output of audio analysis engines 136 or textual analysis components 140 can be stored in storage device 134 or any other storage device, together or separately from the captured or logged interactions.

The results of textual analysis components 140 are then passed to any one of a multiplicity of uses, such as but not limited to visualization tools 144 which may be dedicated, proprietary, third party or generally available tools, result manipulation tools 148 which may be combined or separate from visualization tools 144, and which enable a user to change, add, delete or otherwise manipulate the results of textual analysis components 140. The results can also be output to any other uses 152, which may include statistics, reporting, alert generation when a particular topic becomes more or less important, or the like.

Any of visualization tools 144, result manipulation tools 148 or other uses 152 can also receive the raw interactions or their textual representation as stored in storage device 134. The output of visualization tools 144, result manipulation tools 148 or other uses 152, particularly if changed for example by result manipulation tools 148 can be fed back into textual analysis components 140 to enhance future textual analysis.

In some embodiments, the audio interactions may be streamed to audio analysis engines 136 and analyzed as they are being received. In other embodiments, the audio may be received as one or more chunks, for example 2-30 seconds chunk, such as 10 seconds chunks.

In some embodiments, all interactions undergo audio analysis while in other embodiments only specific interactions are processed, for example interactions having a length between a minimum value and a maximum value.

It will be appreciated that different, fewer or additional components can be used for various organizations and environments. Some components can be unified, while the activity of other described components can be split among multiple components. It will also be appreciated that some implementation components, such as process flow components, storage management components, user and security administration components, audio enhancement components, audio quality assurance components or others can be used.

The apparatus may comprise one or more computing platforms, executing components for carrying out the disclosed steps. Each computing platform can be a general purpose computer such as a personal computer, a mainframe computer, or any other type of computing platform that is provisioned with a memory device (not shown), a CPU or microprocessor device, and several I/O ports (not shown). The components are preferably components comprising one or more collections of computer instructions, such as libraries, executables, modules, or the like, programmed in any programming language such as C, C++, C#, Java or others, and developed under any development environment, such as .Net, J2EE or others. Alternatively, the apparatus and methods can be implemented as firmware ported for a specific processor such as digital signal processor (DSP) or microcontrollers, or can be implemented as hardware or configurable hardware such as field programmable gate array (FPGA) or application specific integrated circuit (ASIC). The software components can be executed on one platform or on multiple platforms wherein data can be transferred from one computing platform to another via a communication channel, such as the Internet, Intranet, Local area network (LAN), wide area network (WAN), or via a device such as CDROM, disk on key, portable disk or others.

Referring now to FIG. 2, showing a schematic flowchart detailing the main steps in a method for data exploration of automatic transcripts being executed by 136 and 140 of FIG. 1.

On 200, a corpus comprising one or more interactions is received. Each interaction can be an audio interaction such as a telephone call which can contain one or more sides of a phone conversation taken over any type of phone including voice over IP, a recorded message, a vocal part of a video capture, or the like. In some embodiments, the corpus can be received by capturing and logging the interactions using suitable capture devices. Each interaction can also be a textual interaction, such as an e-mail, chat session, blog post, social media post, or any other.

On optional step 204, audio analysis is performed over the received interactions which are audio interactions or comprise an audio component. The audio analysis can include, for example, speech to text, word spotting, emotion analysis, call flow analysis, talk analysis, or the like. Call flow analysis can provide for example the number of transfers, holds, or the like. Talk analysis can provide the periods of silence on either side or on both sides, talk over periods, or the like.

The operation and output of one or more engines can be combined, for example by incorporating spotted words, which generally have higher confidence than words spotted by a general S2T process, into the text output by an S2T engine; by searching for words expressing anger in areas of the interaction having high levels of emotion and incorporating such spotted words into the transcription, or the like.

The operation and output of one or more engines can also depend on external information, such as CTI information, CRM information or the like. For example, calls by VIP customers can undergo full S2T while other calls undergo only word spotting. The output of audio analysis 204 is a text document for each processed audio interaction.

On 208 the texts, some of which may have been received on step 200, while others may have been obtained on step 204 undergoes Natural Language Processing (NLP) analysis. NLP analysis may refer to one or more of the following: pre-processing of Part of Speech (POS) tagging, stemming, and optionally additional processing. In addition, one or more texts, such as e-mails, chat sessions or others can also be passed to NLP analysis and the following steps.

POS tagging is a process of assigning to one or more words in a text a particular POS such as noun, verb, preposition, etc., from a list of about 60 possible tags in English, based on the word's definition and context. POS tagging provides word sense disambiguation that gives some information about the sense of the word in the context of use.

Word stemming is a process for reducing inflected or sometimes derived words to their base form, for example single form for nouns, present tense for verbs, or the like. The stemmed word may be the written form of the word. In some embodiments, word stems are used for further processing instead of the original word as appearing in the text, in order to gain better generalization.

POS tagging and word stemming can be performed, for example by LinguistxPlatform™ manufactured by SAP AG of Waldorf, Germany,

Once the text is pre-processed, it is passed to key phrase extraction 212. Keyphrase extraction 212 is a process of identifying words or word sequences, also referred to as terms, phrases or keyphrases, from a given text, wherein the keyphrases may be important or meaningful for the organization. Keyphrase extraction is optionally done using a predefined set of POS rules (linguistic rules) that construct syntactically and semantically coherent word sequences from the given text. Examples for keyphrases may include: “credit card number”, “cancel the account”, “bought a computer”, “local access number”, “wish to cancel”; “freezing”, “cancelling” or the like.

The more accurate and comprehensive is the set of rules, the more indicative is the extracted keyphrases set, and fewer key phrases of lesser importance are extracted.

Keyphrase extraction 212 is performed for each document separately and optionally without linking between different interactions.

Optionally, each keyphrase is assigned a score within the document, such that more important keyphrases, or keyphrases that appear more are assigned a higher score.

Keyphrases are scored for importance on the basis of: a. their structure which relates separately to each occurrence, for example some rules may be more confident so the associated keyphrases will receive higher score; b. their occurrence statistics within the document.

Once key phrase are extracted, they are passed to keyphrase ranking 216.

Since the highest scored keyphrases reflect each document's main topics, these keyphrases can be utilized in exploring the main topics within a document collection (corpus).

For example, they can serve as the basis for clustering document into groups such that each reflects a different theme or constitute objects for clustering by themselves, so that a cluster of keyphrases expresses a unified concept or theme. Clustering of documents may serve as a basis for analyzing relations between keyphrases in the corpus, using a variety of measures that make use of this classification. Ranking can take into account, for example, the statistics of each keyphrase occurrence in the entire document collection and not only regarding a specific document. Thus, the ranking relates to each keyphrase in general, while scoring relates to a keyphrase in the context of a single document.

Keyphrase ranking 216 thus applies statistical measures to attach a rank to each keyphrase, which is independent of any particular interaction or document. Such statistical measures may include variations of Term Frequency—Inverted Document Frequency (TfIdf), TfIdf, information divergence (Kullback-Leibler), mutual information, or others. The statistical measures are known in the art and are explained below for clarity purposes only and should not limit the scope of the disclosure.

TfIdf is a statistical measure used to evaluate how important a word is to a document in a collection The importance of the word or term increases as the number of instances of the word in the document increases, but is reduced as the number of documents that contain the word or term in the corpus increases.

TfPdf: like in TfIdf, the Tf, stands for term frequency. Pdf stands for proportional document frequency. Unlike TfIdf, in TfPdf the measure increases relative to growth in the document frequency.

Information divergence is a measure indicating the difference between two probability distributions, for example in two corpuses.

Mutual Information between two terms measures the contribution of the presence of one term to the presence likelihood of the second term.

It will be appreciated that each of the above detailed measures may have multiple modes of application which can be used according to the particular embodiment implemented. For example, mutual information can be applied ‘pointwise’ to a phrase or to a class, being a subset of the original collection, wherein the class may have been obtained from a previous application of document clustering. TfIdf and TfPdf can be applied ‘pointwise’ to a phrase relative to the entire collection or to a phrase relative to a class, and the like.

The measure determination may take advantage of available metadata features, like the time offset of an utterance within an interaction, and may analyze the patterns of distances in time between different occurrences of the same term throughout the collection.

In some embodiments, each individual document is analyzed vis-à-vis the transcriptions collection as a whole, thus trying to capture keyphrase centrality within the collection.

Once the keyphrases are ranked, relation modeling 220 takes place, in which semantic relations are determined between phrases, considering their ranking. For example, highly ranked keyphrases that appear in multiple common documents may be indicated as having high correlation.

Thus, groups of keyphrases which, when put together, may provide a clear indication of a topic or a theme. Further analysis and visualizations may be based on relations between keyphrases. Semantic relations between documents may also assist in establishing relations between phrases.

The phrases may then be arranged like a graph, or the documents may be partitioned into clusters according to the keywords appearing in each document and their ranks, thus providing a high-level conceptual view of the semantic structure of the document collection. These models may employ metrics such as cosine similarity in a term space, semantic similarity measure based on an external source of lexical information such as WordNet, or the like.

Once the terms and their importance are known, and the relations between terms are determined, topic selection 224 takes place.

On topic selection 224, the framework generated in relation modeling 220 is analyzed. By applying mathematical methods such as computing cluster centroids, finding Eigen-values in a graph or applying a variety of statistical measures, the most prominent and representative keyphrases may be determined, and organized according to their importance and semantic relations to other phrases. The ordering of phrases enables the selection of only a limited number of top rated phrases for presentation from each topic or cluster. The generated clusters may then be regarded as associated with one or more particular issue or topic relevant to the organization.

On visualization 228 the terms and their relationships, the clustering or categorization of documents, or the relations between documents and terms are optionally presented to a user, who can also manipulate the results and provide input, such as indicating specific phrases as important, clustering interactions known to be similar into the same clusters, or the like.

Referring now to FIG. 3, showing an exemplary embodiment of an apparatus for data exploration of automatic transcripts, which details parts 136 and 140 of FIG. 1, and provides an embodiment for the method of FIG. 2.

The apparatus comprises communication component 300 which enables communication among other components of the apparatus, and between the apparatus and components of the environment, such as storage 134, logging and capturing component 132, or others. Communication component 300 can be a part of, or interface with any communication system used within the organization or environment shown in FIG. 1

The apparatus further comprises activity flow manage 304 which manages the data flow and control flow between the components within the apparatus and between the apparatus and the environment,

Optional audio analysis engines 136 may be used for obtaining text or other information form audio interactions, or interactions that comprise an audio component. Audio analysis engines 136 may comprise any one or more of the engines detailed hereinafter.

Speech to text engine 312 may be any proprietary or third party engine for transcribing an audio into text or a textual representation.

Word spotting engine 316 detects the appearance of words from a particular list within the audio. In some embodiments, after an initial indexing stage, any word can be search for, including words that were unknown at indexing time, such as names of new products, competitors, or others.

Call flow analysis engine 320 analyzes the flow of the interaction, such as number and timing of holds, number of transfers, or the like.

Talk analysis engine 324 analyzes the talking within an interaction: during what part of the interaction does each side speak, silence periods on either side, mutual silence periods, or the like.

Emotion analysis engine 326 analyzes the emotional levels within the interaction: when and at what intensity is emotion detected on either side of an interaction.

It will be appreciated that the components of audio analysis engines 136 may be related to each other, such that results by one engine may affect the way another engine is used. For example, anger words can be spotted in areas in which high emotional levels are detected.

It will also be appreciated that audio analysis engines 136 may further comprise any other engines, including a preprocessing engine for enhancing the audio data, removing silences or noises, rejecting audio segments of low quality, or the like, post processing engine, or others.

After the interactions had been analyzed by audio analysis engines 136, the output which contains text automatically extracted from interactions is passed to NLP engine 328 which performs Natural Language Processing (NLP) analysis, which may include but is not limited to Part of Speech (POS) tagging, stemming, or stop words removal.

After the textual preprocessing by NLP engine 328, the processed text is passed to keyphrase extraction component 332, for identifying keyphrases from the text extracted from each of the processed interactions. Keyphrase extraction component 332 optionally uses a predefined set of linguistic rules for constructing syntactically and semantically coherent keyphrases.

The extracted keyphrases are ranked by keyphrase ranking component 336, which applies statistical measures to attach a score to each keyphrase, wherein the score is independent of a particular interaction or document but rather elates to the whole corpus. Such statistical measures may include variations of TfIdf, TfPdf, information divergence, mutual information, Z-score which measures the deviation in frequency of a certain keyphrase in a certain cluster relative to the same keyphrase in all other clusters, or others.

The ranked keyphrases are then processed by relation modeling component 340 that determines semantic relations between phrases, based on their ranking.

Topic selection component 344 is responsible for analyzing the framework generated by relation modeling component 340. By applying mathematical methods such as computing cluster centroids or finding Eigen-values in a graph, the most prominent and representative phrases and interactions are determined, which may be regarded as representing topics relevant for the organization.

The selected topics, and optionally output of the other components such as audio analysis engines 136, keyphrase extraction component 332 or others is then passed to user interface component 348, which presents the data to a user, and optionally enables a user to manipulate, add or delete any data item, such as delete an irrelevant or erroneous term, indicate a connection between terms, or the like.

The disclosed method and apparatus enable the exploration of audio interactions by automatically extracting text and optionally additional data from the interactions, and analyzing the extracted text.

The results' quality depends, among others, on the quality of the extracted texts for example the quality of the speech to text engine. However, as the analyzed corpus is larger, the effect of automatic transcription of low quality decreases, as large-scale statistics may compensate for local errors and, in particular, clustering methods can even highlight speech errors by clustering together variations of miss-captured words along their correct extraction.

It will be appreciated by a person skilled in the art that the disclosed method and apparatus are exemplary only and that multiple other implementations and variations of the method and apparatus can be designed without deviating from the disclosure. In particular, different division of functionality into components, and different order of steps may be exercised. It will be further appreciated that components of the apparatus or steps of the method can be implemented using proprietary or commercial products.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation, material, step of component to the teachings without departing from the essential scope thereof. Therefore, it is intended that the disclosed subject matter not be limited to the particular embodiment disclosed as the best mode contemplated for carrying out this invention, but only by the claims that follow.

What is claimed is:

1. A method for retrieving data from audio interactions associated with an organization, comprising:
receiving a corpus comprising a text document representing an interaction associated with the organization;
performing natural language processing on the text document;
extracting at least one keyphrase from the text document;
assigning a rank to the at least one keyphrase;
modeling relations between at least two keyphrases using the rank; and
identifying topics relevant for the organization from the relations.

2. The method of claim 1 wherein the interaction is an audio interaction, the method further comprising performing audio analysis on the audio interaction to obtain the text document.

3. The method of claim 2 wherein the audio analysis comprises performing speech to text of the audio interaction.

4. The method of claim 2 wherein the audio analysis comprises at least one item selected from the group consisting of: word spotting of the audio interaction; call flow analysis of the audio interaction; talk analysis of the audio interaction; and emotion detection in the audio interaction.

5. The method of claim 1 wherein the natural language processing comprises at least one item selected from the group consisting of: part of speech tagging; word stemming; and stop words removal.

6. The method of claim 1 wherein the at least one keyphrase is ranked within the corpus.

7. The method of claim 1 further comprising visualizing the topics.

8. The method of claim 2 further comprising capturing the audio interactions.

9. The method of claim 1 wherein the interaction is selected from the group consisting of: e-mail, chat session, blog post; and social media post.

10. An apparatus for retrieving data from interactions associated with an organization, comprising:
a natural language processing engine for processing a text document representing an interaction from a corpus of interactions;
a keyphrase extraction component for extracting at least one keyphrase from the text document;
a keyphrase ranking component for assigning a rank to the at least one keyphrase;
a relation modeling component for determining at least one relation between at least two keyphrases using the rank; and
a topic selection component for identifying topics relevant for the organization from the at least one relation.

11. The apparatus of claim 10 wherein the interaction is an audio interaction, the apparatus further comprising an audio analysis engine for analyzing the audio interaction and obtaining the text document.

12. The apparatus of claim 11 wherein the audio analysis engine is a speech to text engine.

13. The apparatus of claim 11 wherein the audio analysis engine is at least one item selected from the group consisting of: a word spotting engine; a call flow analysis engine; a talk analysis engine; and an emotion detection engine.

14. The apparatus of claim 10 wherein the at least one keyphrase is ranked within the corpus.

15. The apparatus of claim 10 further comprising a user interface component for visualizing the topics.

16. The apparatus of claim 10 further comprising a capturing or logging component for capturing or logging the at least one interaction.

17. The apparatus of claim 10 wherein the interaction is selected from the group consisting of e-mail, chat session, blog post; and social media post.

18. A computer readable storage medium containing a set of instructions for a general purpose computer, the set of instructions comprising:
receiving a corpus comprising an interaction associated with an organization;
performing natural language processing on a text document representing an interaction form the corpus;
extracting at least one keyphrase from the text document;
assigning a rank to the at least one keyphrase;
modeling relations between at least two keyphrases using the rank; and
identifying topics relevant for the organization from the relations.
